(19) United States
(12) Patent Application Publication
(10) Pub. No.: US 2013/0232219 A1
(43) Pub. Date: Sep. 5, 2013

(54) INSERTION SYSTEM OF AN AREA FOR INCLUSION OF SEVERAL MESSAGES IN THE WEBSITE BROWSING AREA

(71) Applicants: Diego Barbosa De Faria Brito, Belo Horizonte/MG (BR); Thomas Mesquita Scalioni, Tres Pontas/MG (BR)

(72) Inventors: Diego Barbosa De Faria Brito, Belo Horizonte/MG (BR); Thomas Mesquita Scalioni, Tres Pontas/MG (BR)

(21) Appl. No.: 13/409,550

(22) Filed: Mar. 1, 2012

(51) Int. Cl. G06F 15/16

(52) U.S. Cl. 709/217

(57) ABSTRACT

INSERTION SYSTEM FROM AN AREA FOR SEVERAL TO SEVERAL MESSAGES INCLUSION IN THE WEBSITE BROWSING AREA” specially from a system whereby a manager enabled to operate the system integration of several messages, advertising or not, can, through an insertion area, introduce, operate and modify within this area the related messages in conventional Web sites, the system includes routers (Rn), which, at first version, use a central router (2b) where the centralization occurs, and a second version, a series of routers (Rn) that communicate in sequence, in order to be linked together at one end, to the user (1) and a browser (7) and at the other end, to the server (8) (Web Server), the system applies to a conventional screen website (5), which is introduced into an area (6) designed to messages transmission, advertising or not, which is inserted in location non-overlapping on the original website, the content of messages may be changed by the operator.

### BRIEF SUMMARY OF THE INVENTION

Addressed in this Invention Patent Request an unprecedented “INSERTION SYSTEM OF AN AREA FOR INCLUSION OF SEVERAL MESSAGES IN THE WEBSITE BROWSING AREA” specially of a system through a manager enabled to operate an insertion system of several messages, advertising or not, that may, through an insertion area, introduce, operate and change into this area the related messages in conventional websites through a system that essentially includes the adoption of a set of routers that operate in predetermined sequence, from the user command, that at the end of a logical operational sequence, will have on its website conventional screen, an area with several messages, which may be national or regionalized, creating new ways of messages transmission via the Internet.

### Techniques Fundamentals

The Internet is a conglomerate of worldwide networks of millions of computers connected via TCP/IP protocol that allows access to information and various types of data transfer. It carries a wide variety of features and services, including documents connected by hyperlinks of World Wide Web, and infrastructure to support e-mail and services such as instant communication and file sharing.

According to the Internet World Stats, 1.73 billion people had access to the Internet in September 2009, what represents 25.6% of the world population. According to the survey, Europe had almost 420 million users, more than half the population.

Over 60% of the population of Oceania has Internet access, but this percentage is reduced to 6.8% in Africa. In Latin America and Caribbean, nearly 175 million people have Internet access.

In Brazil, there are 67.5 million Internet users, according to Brazilian Institute of Public Opinion and Statistics (Ibope/Nielsen) in December 2009. In September 2009 were 66.3 million. In other words, in just 3 months arose 1.2 million of new Brazilians over 16 years of age on the Internet. In short, Brazil is the fifth country with the largest number of connections to the Internet.

In urban areas, 44% of the population is connected to the Internet, being this total 97% are companies and 23.8% households connected to the Internet.

Today, regularly access the Internet from their homes, 7.5 million of internauts that number increases to 36.4 million accesses if considered access at work. Of those people, 38% access the web daily, 10% had four to six times per week, 21% two to three times per week and 18% once a week. Adding that, 87% of Brazilian internauts go online weekly.

On the other hand, it should consider those Brazilians who do not access the Internet. According to the 2008, PNAD (National Survey by Household Sampling) 104.7 million people aged ten or over did not use the Internet in the prior three months to the interview, i.e. 65.2% of the total. In three years, the percentage of Brazilians aged ten years or over who accessed at least once the Internet from the computer increased by 75.3%, from 20.9% to 34.8% of people in this age group, or 56 million users in 2008.

### The Internet Structure in the Current State of the Technique Under a Macro and Generic View

FIG. 1 shows an example of a possible structure to operate an Internet system, among many others available today, where users are viewed (1), ISPs (Internet service providers—Internet Service Provider), So-called Backbones (3) to make physical connections between several providers and/or satellites (4). However, this distribution is only exemplified, and subject to available media. Thus, users (1) are those who access the Internet via their computers, while ISPs provide to their customers connection to the Internet, using a default network format (e.g. dialup, ADSL, Wimax, 3G), the backbones (3) capture and transmit information from several smaller networks that connect to it, and the links backbones have high-speed connections to low speed sub-nets.

Yet according to the example in FIG. 1, the information is packaged in accordance with the responsibility of each OSI protocol layer and travel between different machines from various equipment, obeying routes settled dynamically according to the figure mentioned.

### The Operation of the Internet Today

The websites view is performed via TCP/IP, which are based on the OSI model. The set of protocols can be viewed as a layered model, where each layer is responsible for a task group, providing a well-defined set of services for the protocol layer higher. The higher layers are logically closer to the user (called application layer) and deal to more abstract data, relying on lower layer protocols for tasks of lower level of abstraction.

TCP/IP have four layers. The programs communicate with the application layer (example, a browser to display the contents of a website). At the application layer are protocols as SMTP (for email), FTP (for file transfer) and HTTP (for web browsing).

### What is the HTTP Protocol?

The HTPP protocol makes the communication between the client, resource, and the server, it sends a reply message to the client with the request. An HTTP request or response consists of server and via messages. The client sends a request message from multiple fields as, for example, an initial line (Request-Line) Lines of headers (Request-header), a mandatory blank line and an optional message body within these fields is possible to obtain information on the type of text being sent (for example, HTML, Flash or PDF), the coding language (Portuguese, English, French) and the transmitted content (information displayed in the browser, for example, an HTML code).

Within this operating line, by accessing any website, the user receives the page with the characteristics information and images, as well as the advertising messages that are common to the opened website page, thus, the same at all access points.

### The Invention

In the present invention patent request, has developed a system whereby the operator is able to enter into a website any 25 area for messages transmission, whether or not advertising, regardless of the website briefly viewed by the user, these messages can be changed by the system operator and viewed by all users who are using the new Internet system.

Among other innovative aspects, the present invention allows the operator of the new messages transmission system create forms of local or regionalized media transmission, not available on existing websites today.

Hence, any user accessing a desired website, automatically, by the interaction of the new system, will open area or screen that can be positioned as desired, without disturbing the viewing of the original website, with the messages, whether or not advertising, specifics.

In general, the invention may include, preferably, two forms of the system implementation:

Implementation using a central router centralizing the routing of requests of all ISPs;

Implementation by modifying the firmware of all ISPs.

The above versions are respectively represented in FIGS. 2 and 3, and, FIG. 4 shows the sequencing of the router's responses until the HTML code is received from the router with the changes, finishing the routine modification of application layer datagram.

### BRIEF DESCRIPTION OF THE DRAWINGS

Below, the invention will be described in its preferred implementation form, according to figures attached, in which are represented:

FIG. 1: shows an example of a possible structure to operate an Internet system in a conventional manner:

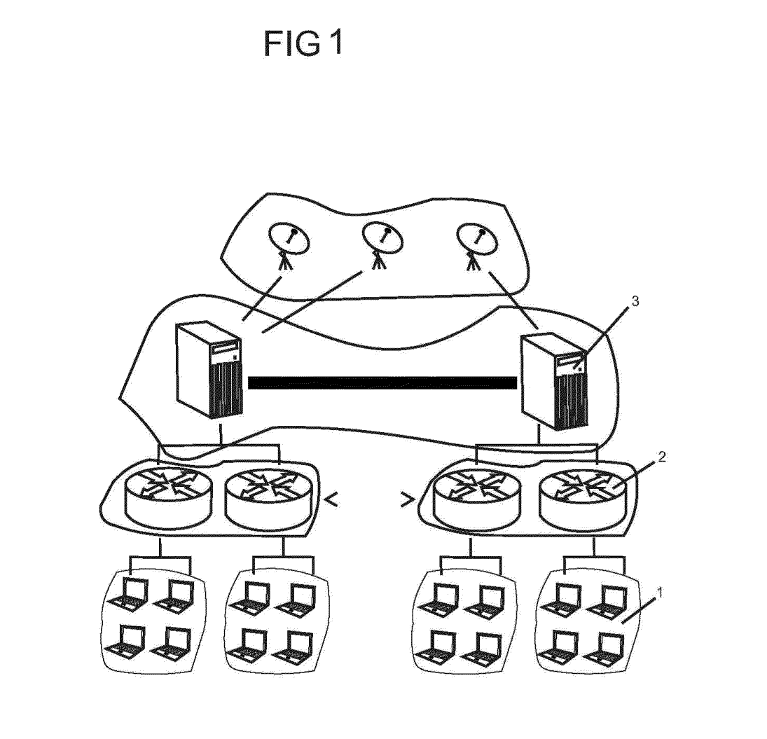

FIG. 2: shows an implementation diagram using a central router centralizing the routing of requests from all ISPs;

FIG. 3: shows an implementation diagram modifying the firmware for all ISPs;

FIG. 4: shows a diagram with an example of HTML code received from the router with the changes;

FIG. 5: shows schematically a hypothetical screen of a website, with the exhibition area of the related website unchanged and an area for messages transmissions and several advertisements via system from the present invention.

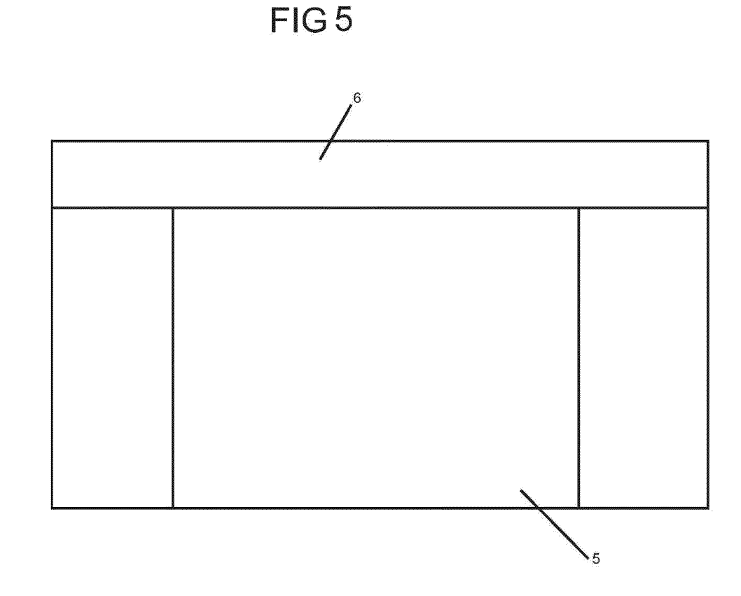

### DETAILED DESCRIPTION OF THE PREFERRED EMBODIMENTS

The “INSERTION SYSTEM FROM AN AREA FOR SEVERAL MESSAGES INCLUSION IN SEVERAL WEBSITE BROWSING AREA” object of this Invention Patent Request, consists of a system that applies to conventional website screen (5), that is an introduced an area (6) for messages transmission, advertising or not, which is inserted into a local without disturbing the viewing of the original website, and can have its message content changed by the operator.

Essentially, this given system includes routers (Rn), that the first version, use a central router (2b) where occurs the centralization and a second version, a series of routers (Rn) that communicate in sequence, so as to be connected at one end, to the user (1) and a browser (7) and in the other end, to the server (8) (Web Server).

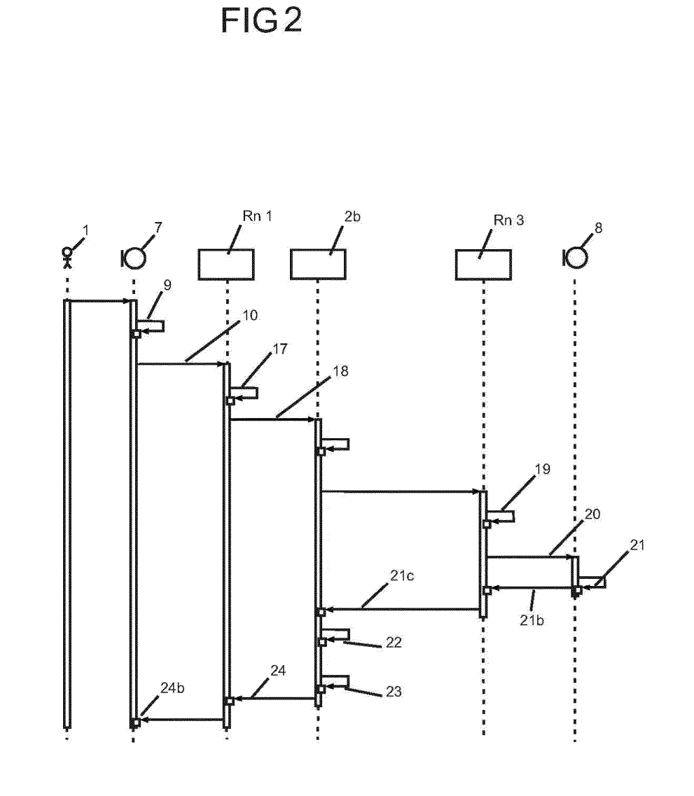

FIG. 2 shows the implementation using a central router centralizing the routing of the requests of all ISPs. For that, it will be 25 necessary to change the routes of all ISPs to a central router (2b), may be done in different ways, for example using a routing protocol called BGP (Border Gateway Protocol).

BGP is a distance vector protocol, but is quite different from other similar, such as RIP. Instead of just keeping the cost for each destination, each BGP router controls which path is being used. Likewise, instead of providing every neighbor estimated cost for each possible destination, the BCP router informs its neighbors the exact path that is being used.

However, the central router (2b) will be responsible for executing routes from that and will make changes into HTTP datagram to insert the HTML frame code.

It is likely that the ideal local to this central router installation (2b) be in a large NAP (Network Access Point). A NAP is a room full of routers (Rn), at least for a backbone (3). A LAN in the room connects all routers (Rn) so that the packets can be forwarded from any backbone (3) to any other backbone.

In the FIG. 2, as an example of system implementation, the user (1) accesses the website with the browser (7), this tries to find the page using the HTTP protocol (9), sending the request to ISP (10) on the router (RN1), which verifies whether the client IP is part of the system (17), when it sends the request (18) for the central router (2b) to perform the routing to the appropriate server (18). Further, the request is sent to the router (Rn . . . 3), which verifies in its IPs list and find the proxy server (19), being this the router, a request is sent (20) to the server (8), it process the 25 request and prepares the response to the browser (7) with HTML code (21). The response is sent (21b) to the router (Rn . . . 3) from the router (21c) to the central router (2b). The central router (2b) opens the package to the application layer to analyze the received data from the HTTP center (22), while the central router (2b) checks the HTTP header whether the content-type is text/HTML type if so, a frame is added at the beginning of the HTML (23). Then, the central router (2b) sends the response to ISP with the frame included in an HTML code (24); finally, the router (RN1) sends response to browser (7) with the frame included (24b).

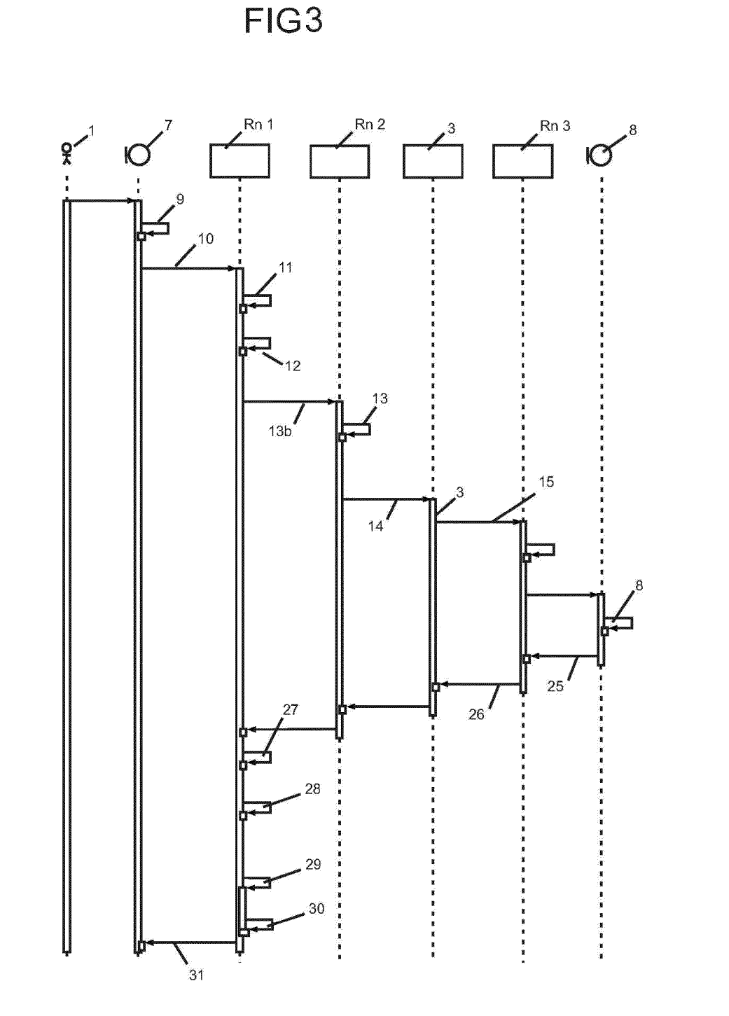

FIG. 3 shows an example of system implementation, implementation version by modifying the firmware of all ISPs. In other words, the ISPs (routers that connect with clients) should be able to modify the application layer to add a small piece of HTML code. For this system, all routers (Rn) (ISPs) should have updates of the firmware (software change) for the operation of the system is contemplated, and the hardware can be any basic configuration for operation via the Internet. Additionally, it is necessary that the ISPs table of routers (Rn) (ISPs) be updated, informing which IPs managed by the router (Rn) are part of the invention.

The routers (Rn) will be able to manipulate application layer data, as shown in FIG. 3 attached, where the user (1), according to the flow shown, access the website with the browser (7), which tries to locate the page using the HTTP protocol (9), then the request is sent to ISP (10) that communicates with the router (RN1) that searches at it IPs list, and if the desired server (11) is not found, the router (RN1) calculate the route to find the sought server (12).

Done that, from the router (21c) to the central router (2b). The central router (2b) opens the package to the application layer to analyze the received data from the HTTP center (22), while the central router (2b) checks the HTTP header whether the content-type is text/HTML type if so, a frame is added at the beginning of the HTML (23). Then, the central router (2b) sends the response to ISP with the frame included in an HTML code (24); finally, the router (RN1) sends response to browser (7) with the frame Included (24b).

FIG. 3 shows an example of system implementation, Implementation version by modifying the firmware of all ISPs. In other words, the ISPs (routers that connect with clients) should be able to modify the application layer to add a small piece of HTML code. For this system, all routers (Rn) (ISPs) should have updates of the Firmware (software change) for the operation of the system is contemplated, and the hardware can be any basic configuration for operation via the Internet. Additionally, it is necessary that the ISPs table of routers (Rn) (ISPs) be updated, informing which IPs managed by the router (Rn) are part of the invention. The routers (Rn) will be able to manipulate application layer data, as shown in FIG. 3 attached, where the user (1), according to the flow shown, access the website with the browser (7), which tries to locate the page using the HTTP protocol (9), then the request is sent to ISP (10) that communicates with the router (RN1) that searches at it IPs list, and if the desired server (11) is not found, the router (RN1) calculate the route to find the server (12).

Done that, the router (RN1) sends the packet (13b) with the request to the router (RN2), this makes the route calculation to find the server (13).

Following the request from the router (RN2), will be sent (14) to a backbone (3), which, in turn, transmits the packet (15) to the router (RN3), which consults its list and finds the server, if the last router, the request (16) is sent to the server (8)

The server (8) processes the request and prepares a response to the browser (7) with the HTML code. Also according to FIG. 3, the response is sent (25) to the router (R3 . . . n) from this (26) to the backbone (3), from this to the router (RN2) and then to the router (RN1). The router (RN1) identifies that the response is destined to an IP that is on its IPs list and provide de sending (27), the machine's IP is identified as an IP address belonging to the plane (28) and the router (RN1) open the packet until the application layer to analyze the data coming from the HTTP (29) and finally, the router (RN1) checks the HTTP header whether content-type is HTML (30) type, if it is, the frame is added at the beginning of the HTML, as final step, the router (RN1) sends the response to the browser (7) included with the frame (31).

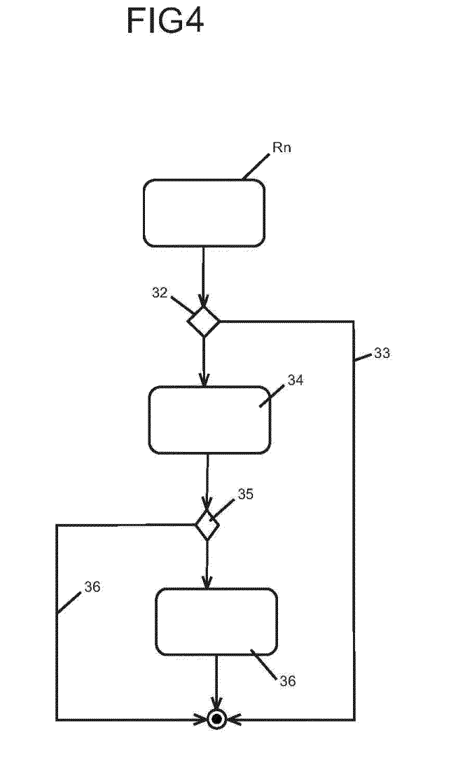

FIG. 4 shows a path of the HTML code received from the router (Rn) with modifications. Thus, the router (Rn) receives a response to be sent to a client, the first check verifies that the IP belongs to the new system (?) (32), in case the response is “no”, the router terminates the routine modification of the bed of application datagram across the path (33), if the response is yes, the router opens the application layer datagram to analyze the fields of the HTTP protocol (34), going directly to the block (35) (content-type=HTML/Text?) if the response is “no” the router ends the routine by path (36) and, if the response is “yes” in the frame is inserted into the HTML (37).

What is claimed:

1. “INSERTION SYSTEM FROM AN AREA FOR SEVERAL TO SEVERAL MESSAGES INCLUSION IN THE WEBSITE BROWSING AREA” especially of a system includes routers (Rn), which in its first version, use a central router (2b) where occurs the centralization, and a second version, a series of routers (Rn) that communicate on sequence, in order to be connected at one end, the user (1) and a browser (7) and at the other end, the server (8) (web Server); CHARACTERIZED BY a system that applies to a conventional website screen, which is introduced into an area (6) for the messages transmission, advertising or not, which is inserted in a non-overlapping location to original website, the content of messages may be changed by the operator, there are ways of setting up the system:—Implementation using a central router centralizing the routing o the requests of all ISPs;—Implementation by modifying the firmware of all ISPs.

2. “INSERTION SYSTEM OF AN AREA FOR INCLUSION OF SEVERAL MESSAGES IN THE WEBSITE BROWSING AREA” according to claim 1, CHARACTERIZED BY this system include routers (Rn), which in its first version, use a central router (2b) where the centralization occurs, and a second version, a series of routers (Rn) that communicate in sequence, so as to be connected at one end, the user (1) and a browser (7) and at the other end, the server (8) (Web Server).

3. “INSERTION SYSTEM OF AN AREA FOR INCLUSION OF SEVERAL MESSAGES IN THE WEBSITE BROWSING AREA”, according to claims 1 and 2, CHARACTERIZED BY the user (1) access the website with the browser (7), and tries to locate the page using the HTTP protocol (9), and the request is sent to ISP (10) on the router (RN1), which verifies whether that the client IP is part of the system (17), when it sends the request (18)for the central router (2b) perform the routing to the appropriate server (18); subsequently, the request is sent to the router (Rn . . . 3), which checks its IPs list and find the proxy server (19), being this the last router, and the same sends the request (20) to the server (8), this processes the request and prepares response to the browser (7) with the HTML code (21), the response is sent (21b) then the router (Rn . . . 3), from that (21c) to the central router (2b), the central router (2b) opens the package until the application layer to analyze the received data center HTTP (22), while the central router (2b) checks the HTTP header field whether the content-type is text/HTML type, if so, it is added to a frame in the beginning of the HTML (23), the central router (2b) sends the response to ISP with the frame included in an HTML code (24), finally, the router (RN1) sends response to browser (7) with the frame included (24b).

4. “INSERTION SYSTEM OF AN AREA FOR INCLUSION OF SEVERAL MESSAGES IN THE WEBSITE BROWSING AREA” according to claims 1 and 2, CHARACTERIZED BY ISPs (routers that connect with the clients) are able to modify the application layer to add a small piece of the HTML code; all routers (Rn) (ISPs) must have firmware updates (software change) for the system operation is contemplated, and the hardware can be either a basic configuration for operation via the Internet, additionally, it is necessary that the table of IPS router (Rn) (ISPs) be updated informing which IPs managed by router (Rn) are part of the invention system.

5. “INSERTION SYSTEM OF AN AREA FOR INCLUSION OF SEVERAL MESSAGES IN THE WEBSITE BROWSING AREA”, according to claim 1, 2 or 4, CHARACTERIZED BY the user (1) access the website with the browser (7), locating the page using the HTTP protocol (9), then the request is sent to the ISP (10) which communicates with the router (RN1) that searches in it IPs list, and if it cannot find the desired server (11), the router (RN1) perform the calculation of the route to find the sought server (12), after that, the router (RN1) sends the packet (13b) with the request to the router (RN2), this makes the route calculation to find the sought server (13), following, the request, from the router (RN2), is sent (14) for a backbone (3), which transmits the packet (15) to the router (RN3), which consults its list and finds the sought server, if this is last router; the request (16) is sent to the server (8), the server (8) processes the request and prepares a response to the browser (7) with the HTML code, the response is sent (25) to the router (R3 . . . n) form this (26) to the backbone (3), from this to the router (RN2) and then to the router (RN1), the router (RN1) identifies that the response is destined to an IP that is on it IPs list s and provides the sending (27), the machine's IP is identified as an IP address belonging to the plane (28) and the router (RN1) opens the package to the application layer to analyze the data coming from the HTTP (29) and finally, the router (RN1) checks if the HTTP header if content-type is HTML type (30), if so, a frame is added at the beginning of the HTML, as final step, the router (RN1) sends the response to the browser (7) included with the frame (31).

6. “INSERTION SYSTEM OF AN AREA FOR INCLUSION OF SEVERAL MESSAGES IN THE WEBSITE BROWSING AREA”, according to claims 1 and 2, CHARACTERIZED BY a path of the HTML code received from the router (Rn) with the modifications, where the router (Rn) receives a response to be sent to a client, the first check verifies whether the IP belongs to the new system (?) (32), if the response is “no”, the router terminates the modification routine of the application layers datagram across the path (33); if the response is “yes”, the router opens the application layer datagram to analyze the fields of the HTTP protocol (34), going directly to the block (35) (content-type=HTML/Text?) ; if the response is “no” the router terminates the routine through the path (36) and, if the response is “yes” in the frame is inserted in an HTML code (37).
